(19) United States
(12) Patent Application Publication
(10) Pub. No.: US 2002/0158910 A1
(43) Pub. Date: Oct. 31, 2002

(54) Adaptive menu appliance control with user interface options

(76) Inventor: John Anthony Sharrow, Redmond, WA (US)

Correspondence Address: John A. Sharrow, 7001 Old Redmond Road, Apt. #J-339, Redmond, WA, 98052, US

(21) Appl. No.: 09/785,932

(22) Filed: Feb. 16, 2001

Related U.S. Application Data
(60) Provisional application No. 60/184,111, filed on Feb. 17, 2000.

(51) Int. Cl. G06F 3/00

(52) U.S. Cl. 345/810; 345/819

(57) ABSTRACT

A simplified, self-prompting user interface for electronically-controlled appliances. A series of simple menus is displayed, and each choice brings an appropriate next level menu, leading the user to make all necessary selections to use the appliance, without requiring instruction or training prior to use. Additional features include the ability to display user menus in a variety of languages, options to announce displayed information audibly, to make selections verbally, and to control the appliance remotely or from a personal computer. An interactive fault isolation diagnostic routine can also be implemented using this invention.

### BACKGROUND OF THE INVENTION

The present invention relates to commercial and household appliances and machines, specifically to an improved user interface for appliances and machines that employ microprocessors, microcontrollers, or other computing devices.

For many years, appliances have used electromechanical timers, switches, and indicators, which enabled a user to select desired functions, monitor status, and control machine operation. Through a combination of refinement and familiarity, operating such appliances became more or less intuitive to most users.

More recent designs use electronic circuitry, which can add to the performance and functionality of the products. Unfortunately, user interfaces have now become more complex and less intuitive. The typical array of switches, displays, visual and aural indicators, and the intricate programming steps for new appliances can be intimidating and confusing.

Comprehensive manuals and video tapes are often supplied, in the hope of training the user and allowing the new features to be used productively, but these are often of limited help. Those whose native language is different from that used in preparing the manuals and tapes have even more difficulty. And aside from the option of adding Braille markings, little effort has been spent in making appliances easier to use for those with impaired vision or other physical limitations.

### SUMMARY OF THE INVENTION

The object of the present invention is to provide an improved, simplified user interface for appliances with electronic controls, correcting the above-described shortcomings of prior art. This invention is applicable to a wide variety of appliances, and offers a consistent, standardized user interface, regardless of complexity. In fact, the more complex the operation of the machine, the greater the benefit derived from employing the invention disclosed herein.

Instead of a conventional approach of labeling a relatively large number of switches and indicators with their associated functions, a single, multi-line display serves to prompt a user, to advise status, and to label a few switches, which are located along the lower perimeter of the display.

By displaying menu text that identifies parameters being chosen on the upper lines of the display and using the bottom line of the display to label the switches, the software program of an electronic controller can lead the user through a number of steps, and the user can readily communicate choices back to the program. Employing a series of these small, adaptive menus, this invention provides an intuitive, interactive method of controlling an appliance, without the need for training or instruction.

This invention also offers the capability to communicate with a user in any language which can be presented on the display. In fact, a first level menu can be programmed to allow a user to select from a choice of preprogrammed languages. A speech generation circuit can be added, simplifying use of the appliance by vision-impaired persons, and a speech recognition circuit can be added, allowing users with physical limitations to control the appliance.

The user interface herein described readily lends itself to remotely controlled operation, which may be implemented by means of an appropriate hand-held device, or through interconnection with a properly equipped terminal or computer.

As an additional benefit, a comprehensive diagnostic routine can be implemented, to lead a user through a series of fault isolation steps and identify the cause of a problem.

### BRIEF DESCRIPTION OF THE DRAWINGS

The above and many other objects, features, and advantages of this invention will become apparent to the reader of the accompanying detailed description, particularly when reviewed with reference to the respective drawings.

FIG. 1 is a block diagram of a typical microprocessor-based appliance controller, showing a user interface display and switches, according to the present invention.

FIG. 2 is an appliance with a control panel with a display and switches, configured as described in the present invention.

FIG. 3 is detail view of a display and associated switches, as shown in FIG. 2.

FIG. 4 is the block diagram of FIG. 1, modified to show how an appliance can be controlled remotely, through the use of this invention.

FIG. 5 is the block diagram of FIG. 1, modified to show an appliance configured as described herein, interconnected with a personal computer.

FIG. 6 is the block diagram of FIG. 1, modified to show the addition of a speech generation circuit and a speech recognition circuit.

FIG. 7 is a flow chart for a combination clothes washer/dryer, employing a user interface as herein described.

FIG. 8 is a flow chart for a fault isolation diagnostic routine.

### DESCRIPTION OF A PREFERRED EMBODIMENT

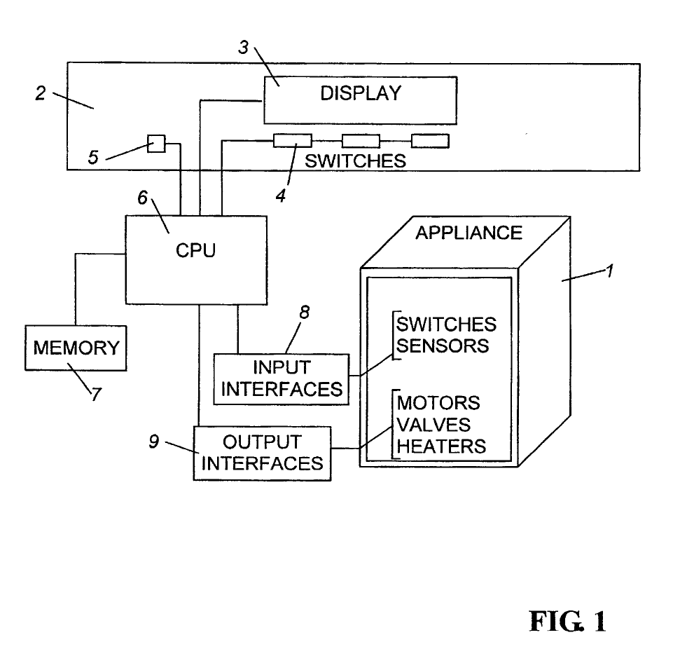

Referring to the accompanying drawings, and initially to FIG. 1 thereof, an appliance 1 will serve to illustrate a preferred embodiment of the present invention.

As the block diagram of FIG. 1 illustrates, appliance 1 employs a central processing unit or CPU 6 to control its operation. CPU 6 can be interfaced to a display 3 and to a number of discrete switches 4, to allow data to be presented to a user and to permit a user to submit data as input bits to CPU 6. Depending on the specific appliance and the functions and features incorporated therein by its designer, the characteristics of the CPU 6, display 3 and switches 4 may vary.

Depending on system requirements, CPU 6 may be a microprocessor, a microcontroller, or an equivalent computing device. A software program, which is stored in a memory device 7, contains the instruction code for CPU 6.

A typical display 3 will be capable of presenting two to four lines of text, with 20 to 40 characters per line. This may be a character or a graphics display, employing liquid crystal, light emitting diode, cathode ray tube, fluorescent, or other appropriate technology.

Three to six switches 4 are typically used, located proximal to the bottom line of a display 3. A variety of switches may be employed, including but not limited to, electromechanical, capacitive, or touch panel overlay types. In addition to the program-labeled switches, certain discrete switches 5 may also be used, such as on/off, pause, reset, repeat, and other dedicated functions.

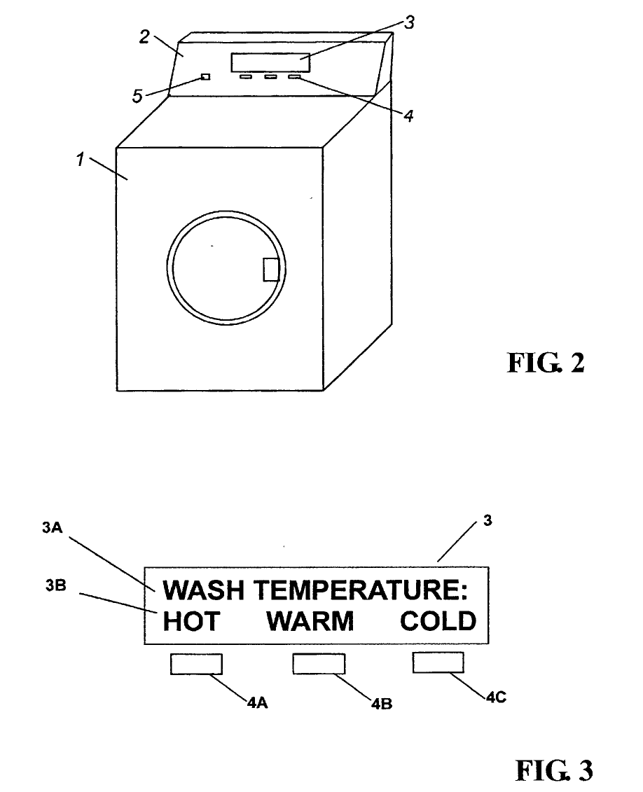

FIG. 2 shows a representative control panel 2, configured with a two line display 3 and three switches 4. As illustrated in FIG. 3, information is presented on display 3, under control of the software program stored in memory 7. Display 3 shows instructions and prompts on a top line 3A, with switch function labels on a bottom line 3B. Switches 4A, 4B, and 4C allow a user to present selections to CPU 6 data inputs, which are then read by the software program stored in memory 7, to determine the desired operating modes and functions.

In contrast to the control panel complexity of a conventional laundry appliance, control panel 2 as shown in FIG. 2 is notably simple. Rather than presenting a user with a switch, a label, and an indicator for every possible operational choice or function, the present invention utilizes a series of small menus presented on display 3, each of which elicits a single selection, which is entered through the use of switches 4.

The menus are adaptive, so that each user selection tells the software program stored in memory 7 to branch to an appropriate subsequent program section, which displays a next menu and waits for a respective user input, until all required choices have been entered. In this manner, this invention leads a user through a series of steps, prompting for an appropriate choice at each step, allowing an inexperienced user to successfully control operation of appliance 1.

Key features of this adaptive approach are that each menu brings a list of just a few possible choices which can be understood quickly, and that successive menus only show the choices required subsequent to a previous selection. With only a few keystrokes, a user can select from dozens or even hundreds of possible combinations, to direct appliance 1 to perform the desired operations.

The simplicity of the present invention also makes it possible to add features that would overly complicate operation of an appliance with a conventional user interface. With the same display 3 and switches 4 on control panel 2, a designer can offer different functions and different performance levels, without changing anything but an appliance's software program.

With all necessary user input solicited through text presented on display 3, CPU 6 can be programmed to interact with a user in any language which can be reasonably represented on the type of display used. This permits a software program to be designed to present a user with a choice of languages, either at the beginning of operation or at the beginning of a cycle. If desired, this choice of language can be presented only when appliance 1 is plugged in for the first time, continuing to operate in a selected language until appliance 1 is either unplugged or CPU 6 is deliberately reset.

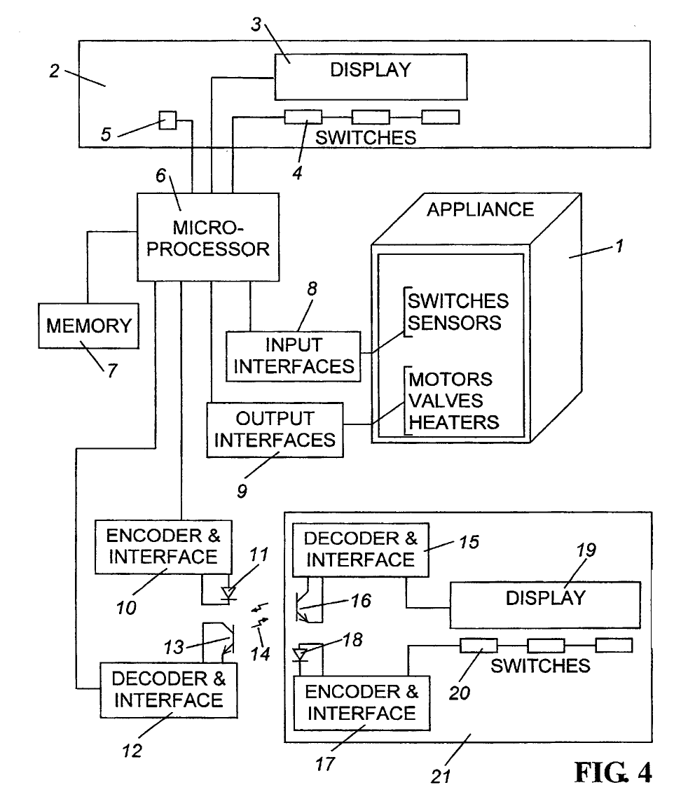

As shown in FIG. 4, a display 19 and switches 20 can be duplicated on, or located on, a remote control unit 21 so that a user can control appliance 1 from a convenient distance. Such a remote control function can be implemented as shown, using an infrared link 14, employing standard commercially-available emitters 11 and 18, sensors 13 and 16, and encoding, decoding, and interface circuitry. Alternatively, the remote control unit 21 can be connected to CPU 6 through the use of a wired, RF wireless, or other suitable medium.

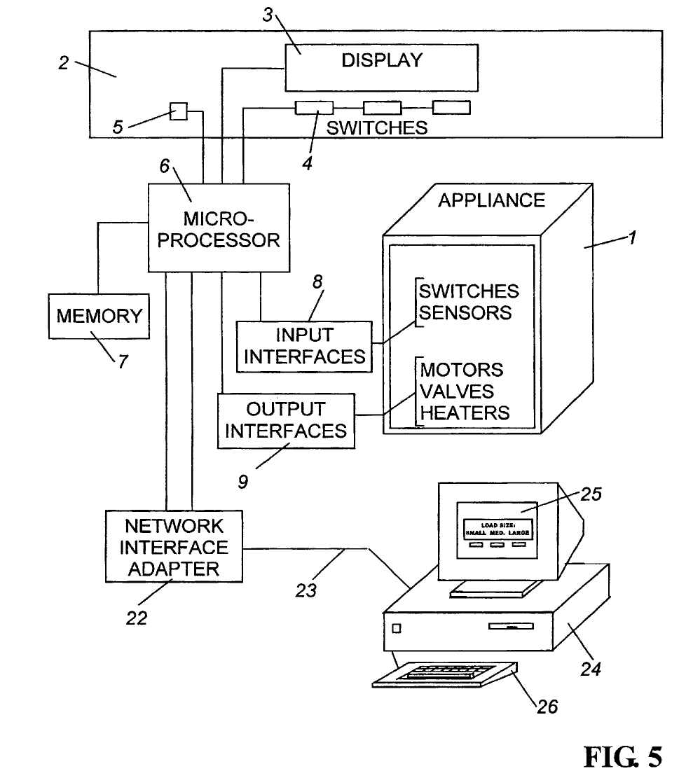

FIG. 5 illustrates how the display 3 and switches 4 can be controlled from, or duplicated on, a personal computer 24 or an equivalent data terminal. A software program contained in memory 7 directs CPU 6 to send information to network interface adapter 22 that is equivalent to data sent to a control panel display 3. The output from network interface adapter 22 is transmitted to personal computer 24 via network interconnection medium 23.

The network interconnection medium 23 may be wires, a fiber optic cable, a wireless system, or an equivalent means of transferring data Through the use of standard, commercially available interface products, such as network adapters and modems, an appliance and a computer may be interconnected via a network as shown in FIG. 5, connected directly or by modem, or accessed through the internet.

A software program running on personal computer 24 receives and processes the data received via network medium 23 and presents the display information on the screen of monitor 25. Similarly, the software program running on personal computer 24 receives and processes data from keyboard 26, or an equivalent input device, and sends this data via network medium 23 to network interface adapter 22. The software program contained in memory 7 directs CPU 6 to read and utilize information from network interface adapter 22 as equivalent to data from control panel switches 4, thus controlling operation of appliance 1.

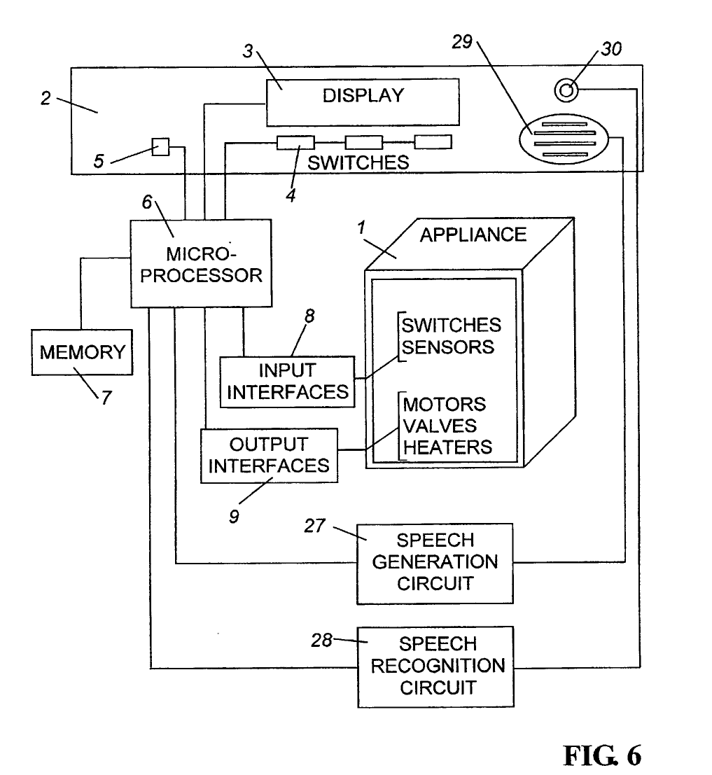

Since all required instructions, prompts, and advisories are sent to display 3, it is a relatively simple task to modify the appliance controller as shown in FIG. 6, to have CPU 6 send equivalent data to a speech generating circuit 27, which then will audibly announce the displayed information to a user, through loudspeaker 29 or an equivalent audio transducer. This can be particularly beneficial for vision-impaired users.

Further, since most or all required user input can be obtained from a small number of switches 4, FIG. 6 also shows that a speech recognition circuit 28 can be added, to process a similar number of words or sounds. This allows users with physical limitations to successfully use an appliance by speaking into microphone 30. Carried to its simplest form, handclaps, whistles, or other selected sounds could control an appliance so equipped.

It is to be understood that the present invention may incorporate the above-described speech generation circuit 27, the speech or sound recognition circuit 28, or a combination of both. In fact, a user interface can contain any combination of remote controls, personal computer links, speech circuits, visual displays, and switches.

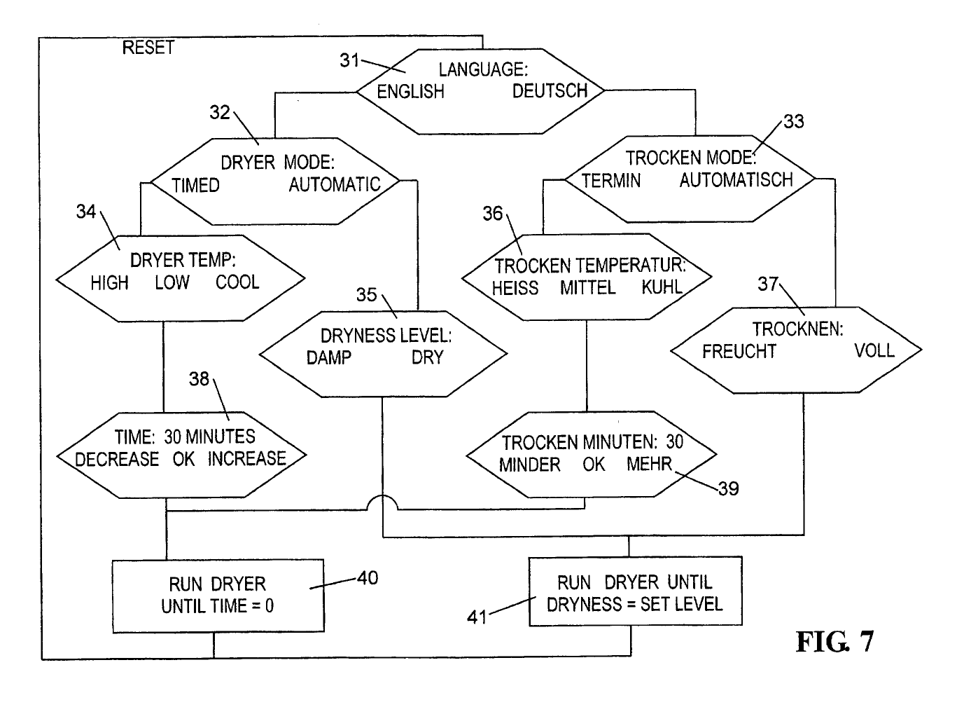

With an appliance configured as shown in FIG. 1 and referring to the detail drawing of FIG. 3 and the flow chart of FIG. 7, the following represents a typical use of an appliance with a user interface configured according to the present invention. In this example, a clothes dryer is shown, programmed to allow a user to select either English or German as the operating language.

Initially, line 3A of display 3 prompts a user to select a language, which will then be used throughout the remaining menus, for the current operating cycle. For the purpose of this throughout the remaining menus, for the current operating cycle. For the purpose of this example, assume that the user presses switch 4A, choosing English as the language 31. It will be apparent from a review of FIG. 7 that selecting English as the language will cause the software program stored in memory 7 to follow a sequence of blocks 32, 34, 35, 38, and 40 or 41, whereas selecting German will cause the program to follow a sequence of blocks 33,36,37,39, and 40 or 41.

In accordance with the adaptive nature of this user interface, the software program stored in memory 7 records this selection, then proceeds to send the next prompt to line 3A of display 3 and the next switch labels to line 3B of display 3, as shown in block 32.

This time, the user presses switch 4A to select a timed drying mode. As before, the software program stored in memory 7 records the selection and sends the next prompt to line 3A of display 3 and the next switch labels to line 3B of display 3, as shown in block 34.

Desiring a low drying temperature for delicate fabrics, the user presses switch 4B. This selection is recorded by the software program stored in memory 7 and lines 3A and 3B of display 3 are updated as shown in block 38.

In this case, the user is allowed to increase or decrease the drying time from the initial 30 minute period. Pressing switch 4A will decrease the drying time, switch 4C will increase the time, and switch 4B will accept the time setting shown on line 3A of display 3 and will signal the software program stored in memory 7 to initiate the drying cycle.

When switch 4B is pressed, the software program stored in memory 7 records the time setting as shown on line 3A of display 3 and applies power to the motor, heater, and other devices in the clothes dryer to begin the drying process.

Since the selected cycle is set to run for a specific time period, the software program stored in memory 7 decrements the time until a value of zero is reached, at which time power will be removed from the motor, heater, and other devices in the clothes dryer, terminating the

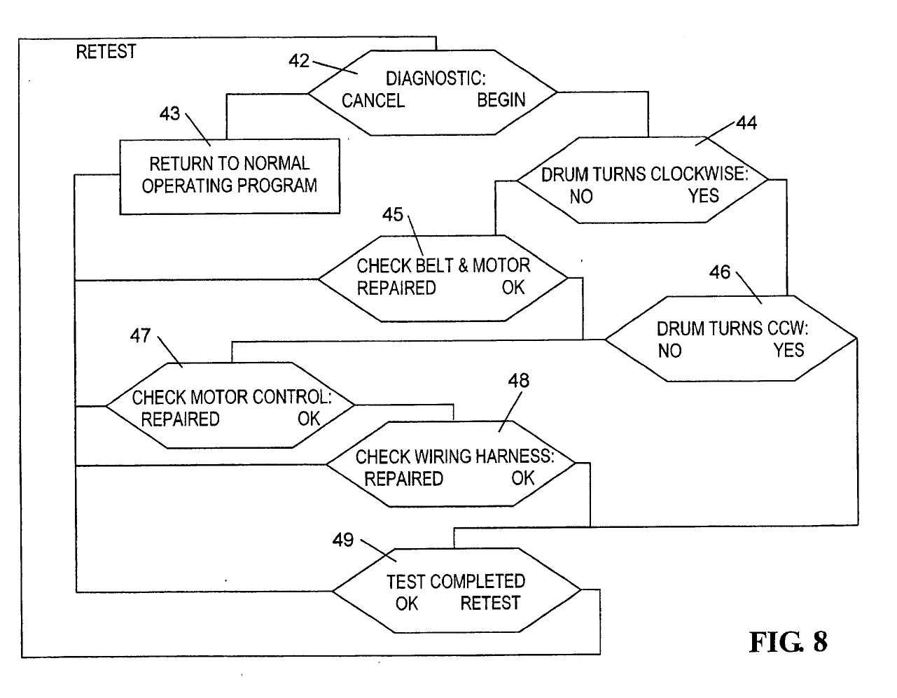

In a similar manner, FIG. 8 illustrates a typical diagnostic routine, as implemented for the user interface herein defined.

As shown in block 42, a user is first given a choice of beginning the diagnostic routine, or canceling and returning to the normal operating program 43. As described above with reference to the flow chart of FIG. 7, at each level of the menu, the software program stored in memory 7 sends a prompt to line 3A of display 3 and switch labels to line 3B of display 3, then records the user input from switches 4A, 4B, and 4C.

A series of menu steps, blocks 44 through 49, prompts the user to check for specific actions or to test particular components, in a predetermined fault isolation sequence. Employing the adaptive feature of the present invention, the user is presented only with the steps and choices that are appropriate in light of each preceding answer. At each of the troubleshooting blocks, 45, 47, and 48, pressing switch 4A indicates that a fault was repaired and returns operation to the normal program.

If the results of all tests are satisfactory, as indicated by pressing switch 4C at blocks 44 through 48, the software program stored in memory 7 jumps to block 49, showing that the diagnostic routine has been successfully completed. This gives the user a choice of returning to the normal operating program or returning to block 42 to repeat the tests.

Those skilled in the art will recognize that many changes and modifications can be made to the method and apparatus herein described, without departing from the scope and spirit of this invention, as described in the appended claims.

I claim:

1. A user interface and control method for an appliance equipped with a computer-based electronic control system, said user interface and control method comprising:
providing said computer-based electronic control system with a display means for presenting at least two lines of information to a user;
positioning a plurality of switch means adjacent to the lower perimeter of said display and interconnecting said switch means with said computer-based electronic control system;
programming said computer-based electronic control system to present at least one menu prompt or instruction on an upper line of said display means;
programming said computer-based electronic control system to accept data inputs from said switch means, enabling said user to indicate a desired mode or function for said appliance to perform;
programming said computer-based electronic control system to present at least two menu selection choices on a lower line of said display means proximal to said switch means;
programming said computer-based electronic control system to present at least one subsequent menu with selection choices determined by said desired mode or function selected by said user from a previous level menu, allowing said user to indicate an operation that said user wishes said appliance to perform.

2. The method of claim 1, further comprising:
programming said computer-based electronic control system to present menu prompts, instructions, and selection choices to enable said user to select one of at least two languages, at the beginning of an operation or cycle;
programming said computer-based electronic control system to present all subsequent information and menus on said display in said user-selected language, until the cycle is completed, the system is reset, or power is removed.

3. The method of claim 1, further comprising:
locating or duplicating said display means and said switch means on a remote control unit;
connecting said remote control unit to said computer-based electronic control system through an interconnect means;
programming said computer-based electronic control system to allow said user to control at least one function of said appliance from said remote control unit.

4. The method of claim 1, further comprising;
simulating or duplicating said display means and said switch means on a personal computer or data terminal;
connecting said personal computer or data terminal to said computer-based electronic control system through a network interconnection means;
programming said computer-based electronic control system to allow said user to control at least one function of said appliance from said personal computer or data terminal.

5. The method of claim 1, further comprising:
interconnecting a commercially available speech emulation means, any one of several types known to those skilled in the art, with said computer-based electronic control system;
programming said computer-based electronic control system to cause said speech emulation means to emit an aural equivalent to the information presented on said display means.

6. The method of claim 1, further comprising:
interconnecting a commercially available speech recognition means, any one of several types known to those skilled in the art, with said computer-based electronic control system;
programming said computer-based electronic control system to accept signals from said commercially available speech recognition means as equivalent to signals from respective said switch means, allowing selection of said desired mode or function in response to specific words or sounds.

7. A user interface and control apparatus for an appliance equipped with a computer-based electronic control system, said apparatus comprising:
a display means for presenting at least two lines of information to a user, interconnected with said computer-based electronic control system;
a plurality of switch means positioned adjacent to the lower perimeter of said display and interconnecting with said computer-based electronic control system;
said computer-based electronic control system being programmed to present at least one menu prompt or instruction on an upper line of said display means;
said computer-based electronic control system being programmed to accept data inputs from said switch means, enabling said user to indicate a desired mode or function for said appliance to perform;
said computer-based electronic control system being programmed to present at least two menu selection choices on a lower line of said display means proximal to said switch means;
said computer-based electronic control system being programmed to present at least one subsequent menu with selection choices determined by said desired mode or function selected by said user from a previous level menu, allowing said user to indicate an operation that said user wishes said appliance to perform.

8. The apparatus of claim 7, further comprising:
said computer-based electronic control system being programmed to present menu prompts, instructions, and selection choices to enable said user to select one of at least two languages, at the beginning of an operation or cycle;
said computer-based electronic control system being programmed to present all subsequent information and menus on said display in said user-selected language, until the cycle is completed, the system is reset, or power is removed.

9. The apparatus of claim 7, further comprising:
a remote control unit duplicating said display means and said switch means;
an interconnect means connecting said remote control unit to said computer-based electronic control system;
said computer-based electronic control system being programmed to allow said user to control at least one function of said appliance from said remote control unit

10. The apparatus of claim 7, further comprising:
a personal computer or data terminal configured to simulate or duplicate said display means and said switch means;
a network interconnection means connecting said personal computer or data terminal to said computer-based electronic control system;
said computer-based electronic control system being programmed to allow said user to control at least one function of said appliance from said personal computer or data terminal.

11. The apparatus of claim 7, further comprising:
said computer-based electronic control system interconnected with a commercially available speech emulation means, any one of several types known to those skilled in the art;
said computer-based electronic control system being programmed to cause said speech emulation means to emit an aural equivalent to the information presented on said display means.

12. The apparatus of claim 7, further comprising:
said computer-based electronic control system interconnected with a commercially available speech recognition means, any one of several types known to those skilled in the art;
said computer-based electronic control system being programmed to accept signals from said commercially available speech recognition means as equivalent to signals from respective said switch means, allowing selection of said desired mode or function in response to specific words or sounds.
